(19) United States
(12) Patent Application Publication
(10) Pub. No.: US 2026/0317861 A1
(43) Pub. Date: Oct. 15, 2026

(54) Process For Selective Recovery Of Rare Earth Elements (REEs) From Spent Neodymium Iron Boron (NdFeB) Magnets.

(71) Applicants: INDIAN INSTITUTE OF TECHNOLOGY KHARAGPUR, Kharagpur, West Bengal (IN); REMA GLOBAL PRIVATE LIMITED, Andhra Pradesh (IN)

(72) Inventors: Chenna RAO BORRA, Kharagpur (IN); Sumantra MANDAL, Kharagpur (IN); Venkata Lakshmi BORRA, Kharagpur (IN)

(21) Appl. No.: 19/485,946

(22) PCT Filed: May 9, 2024
(86) PCT No.: PCT/IN2024/050505

§ 371 Date: Nov. 19, 2025

(30) Foreign Application Priority Data
May 19, 2023 (IN) 202331035234

(51) Int. Cl. C22B 59/00; C01F 17/206; C22B 1/00; C22B 3/04; C22B 3/22; C22B 3/44; C22B 7/00

(52) U.S. Cl. CPC C22B 59/00; C01F 17/206; C22B 1/005; C22B 3/04; C22B 3/22; C22B 3/44; C22B 7/006

(57) ABSTRACT

A process is provided for selective recovery of rare earth elements (REEs) from spent neodymium iron boron (NdFeB) magnets comprising steps of (a) providing magnet powder post demagnetizing and pulverizing/milling of neodymium iron boron (NdFeB) magnets for aeration leaching; (b) performing aeration leaching of said magnetic powder for dissolution of REEs including as rare earth salts and completely precipitating iron out as iron oxide and/or hydroxide by-product based on oxidation of Fe²+ to Fe³+ during said aeration leaching and thus generating mother liquor containing rare earth salts followed by (c) reacting the filtered mother liquor with oxalic acid to precipitate rare earth elements as rare earth oxalate for further calcination and obtaining rare earth oxide for rare earth elements (REEs) recovery therefrom, which process is advantageously low in acid consumption, involves low capital cost, low reagent consumption and at the same time enables iron oxide and/or hydroxide as by-product.

### FIELD OF INVENTION

The present invention provides for a process for selective recovery of rare earth elements (REEs) from spent neodymium iron boron (NdFeB) magnets comprising the steps of (a) providing magnet powder post demagnetizing and pulverizing/milling of neodymium iron boron (NdFeB) magnets for aeration leaching; (b) performing aeration leaching of said magnetic powder for selective dissolution of REEs including as rare earth salts and completely precipitating iron out as iron oxide and/or hydroxide by-product based on the oxidation of Fe²+ to Fe³+ during said aeration leaching and thus generating a mother liquor containing the rare earth salts that is followed by (c) reacting the filtered said mother liquor with oxalic acid to precipitate rare earth elements as rare earth oxalate for further calcination and obtaining rare earth oxide for recovery of rare earth elements (REEs) therefrom. The process of the present invention is advantageously capable of selective recovery of rare earth elements (REEs) from spent neodymium iron boron (NdFeB) magnets that is advantageously low in acid consumption, involves low capital cost and low reagent consumption and at the same time enablesiron oxide and/or hydroxideas a by-product.

### BACKGROUND ART

NdFeB magnets are the most common permanent magnets utilized in numerous industries due to their strong magnetic characteristics. These days, special workspaces are needed because of the rise in waste issues and the rapid depletion of rare earth element resources, while recycling used NdFeB magnets has grown significantly in importance. Several recycling techniques, including hydrogen decrepitation chemical vapor transport, aeriometallurgical, pyrometallurgical, electrometallurgical, and hydrometallurgical processes, can recover REEs from magnet scrap. Hydrometallurgical processes are the more conventional among all. In which NdFeB magnet scrap is completely or selectively dissolved in strong mineral or organic acids and the interested REEs are selectively precipitated as double sulfates, oxalates, or fluorides. Selectivity and reaction rates are the key challenges in this method of recycling. Though hydrometallurgical methods achieved the most prominent for recovering appreciable amounts of REEs, they need expensive pretreatment techniques, consume a lot more chemicals which causes inescapable environmental issues and require multiple steps which increase the overall process time. Oxidation of magnet scrap at high temperature followed by selective leaching is another most used process to recover REEs from magnet scrap but it causes environmental pollution due to oxidizing roasting process and capital cost is high due to prolonged high-temperature oxidizing roasting in the process.

### References Are Invited From Literature References as Follows:

Liu et al. [Liu, Z. et al. Separation and coextraction of REEs and Fe from NdFeB sludge by co-leaching and stepwise precipitation. Sep. Purif. Technol.282, 119795 (2022)] recovered REEs from NdFeB sludge by co-leaching of REEs and Fe with hydrochloric acid as leaching media after pretreatment. In this process, energy and acid consumption is high as the magnetic sludge completely dissolved in hydrochloric acid during leaching. Rabatho et al. [Rabatho, J. P., Tongamp, W., Takasaki, Y., Haga, K. & Shibayama, A Recovery of Nd and Dy from rare earth magnetic waste sludge by hydrometallurgical process. J. Mater. Cycles Waste Manag. 15, 171-178 (2013)] investigated the possibility of dissolving the high Nd (35%) content in the magnetic waste sludge by leaching with HNO3 and H2O2 acid solutions. The stage after leaching was Fe removal by precipitation and filtration using pH adjustment with NaOH addition. The final recovery for the process was only 69.7% Nd and 51% Dy with the purity of the final product of Nd2O3 found to be over 68.0%.

Prior patent document on the same relates to CN114574702A discloses a process for recovering rare earth from neodymium iron boron reclaimed materials using hydrochloric acid leaching with hydrogen peroxide as a leaching agent to dissolve rare earth in the feed liquid, iron and boron are both left in the slag and not dissolved. Although the rare earth recovery rate is high, consumption of the amounts of hydrochloric acid, hydrogen peroxide, and ammonia water is large, which directly leads to high energy consumption and the cost.

In view of the above, there is a need in the art to provide a process for the selective recovery of rare earth elements (REEs) from spent neodymium iron boron (NdFeB) magnets that would be facile and less cost extensive involving lower capital cost, low acid consumption, low reagent consumption and enabling iron oxide and/or hydroxide by-product.

### OBJECTS OF THE INVENTION

It is thus a primary object of the present invention to provide a process for the selective recovery of rare earth elements (REEs) from spent neodymium iron boron (NdFeB) magnets that would be facile and less cost extensive.

It is another object of the present invention to provide a process that would involve lower capital cost, low acid consumption, and low reagent consumption.

It is yet another object of the present invention to provide for said process that would provide for iron oxide and/or hydroxide by-product.

### SUMMARY OF THE INVENTION

Thus according to the basic aspect of the present invention there is provided a process for the selective recovery of rare earth elements (REEs) from spent neodymium iron boron (NdFeB) magnets comprising the steps of
(a) providing magnet powder post demagnetizing and pulverizing/milling of neodymium iron boron (NdFeB) magnetsfor aeration leaching;
(b) performing aeration leaching of said magnetic powder for selective dissolution of REEs including as rare earth salts and completely precipitate iron out as iron oxide/hydroxide by-product based on oxidation of Fe²+ to Fe³+ during said aeration leaching and thus generating a mother liquor containing the rare earth chlorides;
(c) reacting the filtered said mother liquor with oxalic acid to precipitate rare earth elements as rare earth oxalate for further calcination and obtaining rare earth oxide and/or hydroxide for recovery of rare earth elements (REEs) therefrom.

Preferably in said process for the selectiverecovery of rare earth elements (REEs) wherein said step (a) involves demagnetization of neodymium iron boron (NdFeB) magnets at a temperature above curie temperature (400-500 °C), for a duration of 1 hr where magnetic properties disappear including by involving externally applied magnetic field, mechanical shock treatment, that is followed by pulverizing the demagnetized material to a size of <500 μm based on mechanically pulverizing by including hydrogen decrepitation and/or grinding, ball milling to obtain said magnet powder with an enhanced surface area that is sieved to obtain both undersize and oversize powders.

According to another preferred aspect of the present invention there is provided a process for the selective recovery of rare earth elements (REEs) wherein said step (b) of performing aeration leaching by selective dissolution of REEs as rare earth salts involve adding said undersized and oversized magnet powders to water and acid where both REEs and ferrous/ferric salt were leached in the presence of air for a duration of 1-12hours at a pH in the range of 1 to 7 at a temperature of leaching in the range of room temperature of 20-40 °C to 100 °C and with 5-2000 rpm stirring speed, providing rare earth salts and ferrous salts that reacts with dissolved oxygen of the air or enriched oxygen of the air or oxygen or ozone to be converted to ferric salts that in unstable in the pH range to be dissociated to iron oxide and/or hydroxide for releasing the acid which acid further reacts with the undissolved magnet powder for continuing the process of aeration leaching until the magnet powder is completely consumed to thereby favour mother liquor containing rare earth salts and a residue containing iron oxides and/or hydroxides as by-product obtained in yields of more than 90%.

Preferably in said process for the selective recovery of rare earth elements (REEs) is provided wherein in said step (b) said magnet powder to acid is provided in the ratio range of I:2 to I:100 with said acid including organic, inorganic acids.

More preferably in said process for the selectiverecovery of rare earth elements (REEs) wherein said step (c) involves reacting the filtered mother liquor minus the residue including iron oxides and/or hydroxides and having negligible Fe²+, with oxalic acid to precipitate rare earth elements (REEs) in the form of rare earth oxalates that was calcined in air at 800 °C to obtain rare earth oxides.

According to another preferred aspect of the process for the selective recovery of rare earth elements (REEs) wherein during leaching in step (b) the acid concentration is such that it is high enough to start iron precipitation and low enough to keep rare earths in the solution in pH range of 1-6.

Preferably in said process for the selective recovery of rare earth elements (REEs) facilitates decreased acid consumption for selective recovery of rare earths from magnets with attainable REEs yield of 99% with 99% purity vide the process.

More preferably in said process for the selective recovery of rare earth elements (REEs) wherein spent neodymium iron boron (NdFeB) magnets include pre-consumer scrap and residues, including magnetic swarf, rejected magnets, REEs containing residue during metal production, electric arc furnace residue, and industrial residue, or end-of-life products comprised of compact fluorescentlamps, LEDs, LCD backlights, plasma screens, cathode ray tubes, magnets, automobiles (motor magnets, switches, sensors, actuators), mobile phones (speakers, switches), Hard Disk Drives (HDDs), consumer electric and electronic appliances, electric and hybrid vehicles, wind turbine generators, nickel metal halide batteries, and catalysts.

In an aspect, the present invention thus provides a process for recovering REEs from secondary sources of NdFeB permanent magnets. The process comprises transforming the magnet material to a higher surface area form, treating the transformed magnet material with an aqueous solution of acids in the presence of oxygen (air) flow to selectively leach the REEs to obtain a leached slurry, and filtered the leach slurry to separate a pregnant liquor and a residue followed by treating the pregnant liquor with any precipitating agent to get REEs.

The secondary sources for NdFeB magnets are either pre-consumer scrap and residues, including magnetic swarf, rejected magnets, REEs containing residue during metal production, electric arc furnace residue, and industrial residue, or end-of-life products comprised of compact fluorescent lamps, LEDs, LCD backlights, plasma screens, cathode ray tubes, magnets, automobiles (motor magnets, switches, sensors, actuators), mobile phones (speakers, switches), HardDiskDrives (HDDs), consumer electric and electronic appliances, electric and hybrid vehicles, wind turbine generators, nickel metal halide batteries, and catalysts.

In another aspect, demagnetizing the magnet material by being subjected to a temperature above curie temperature (400-500 °C), where magnetic properties disappear or using an externally applied magnetic field or mechanical shock treatment.

In another aspect, grinding and sample preparation: mechanically pulverized the magnet material using a hydrogen decrepitation and/or grinding or milling to make it a powder to increase the surface area.

In yet another aspect, sieving and size mixing: screening the neodymium iron boron powder obtained in the second step by a sample separation screen to get undersize and oversize powders.

In yet another aspect, leaching is carried out by adding water and acid or ferrous/ferric salts to undersize powders for the leaching duration in the range of 1-12hours at a pH in the range of 1 to 7 at a temperature of leaching is in the range of RT to 100 °C at a stirring speed of 5-2000 rpm.

In yet another aspect, the ratio of a compound containing REEs to water and acid or ferrous/ferric salt is 1:2 to 1:100. The process further comprises aeration with air/oxygen/ozone to convert ferrous ions to ferric, which are insoluble at the given pH and hence precipitate out of solution. In yet another aspect, the leach slurry is filtered to separate a mother liquor containing rare earth salts and the residue containing iron oxides and/or hydroxides for further precipitating the rare earths from the filtered solution by oxalic acid precipitation followed by calcination to generate rare earth oxide compound.

### BRIEF DESCRIPTION OF FIGURES

FIG. 1: illustrates a flowchart of the processing route for recovery of rare earth elements from spent magnets;

FIG. 2: illustrates superimposed-Pourbaix diagrams of Fe-H2O and Nd-H2O systems;

FIG. 3: illustratesimages of leaching studies with and without oxidant;

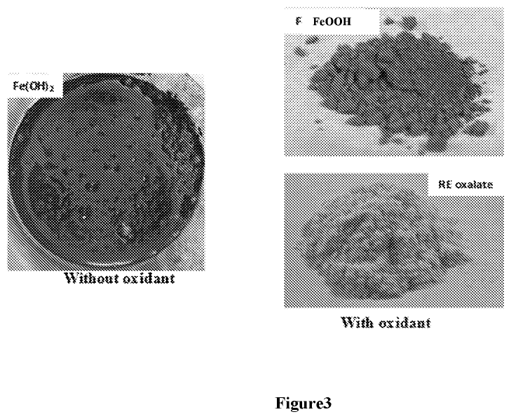

FIG. 4: illustrates X-Ray diffraction pattern of rare earth oxide;

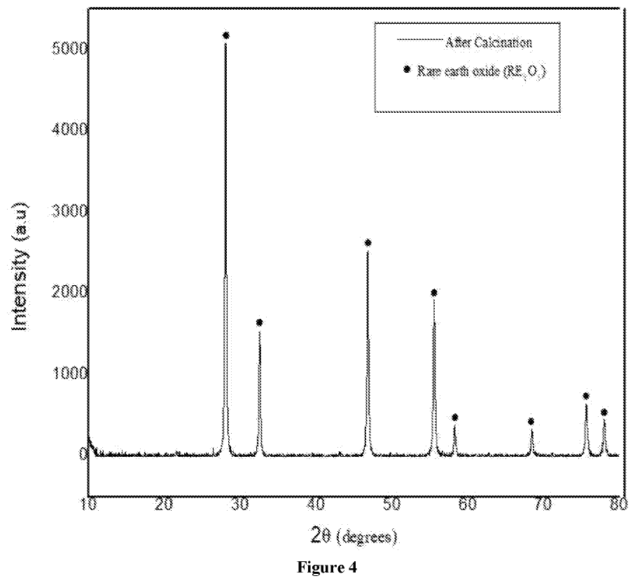

FIG. 5: illustrates energy dispersive X-ray analysis (EDAX) of rare earth oxide;

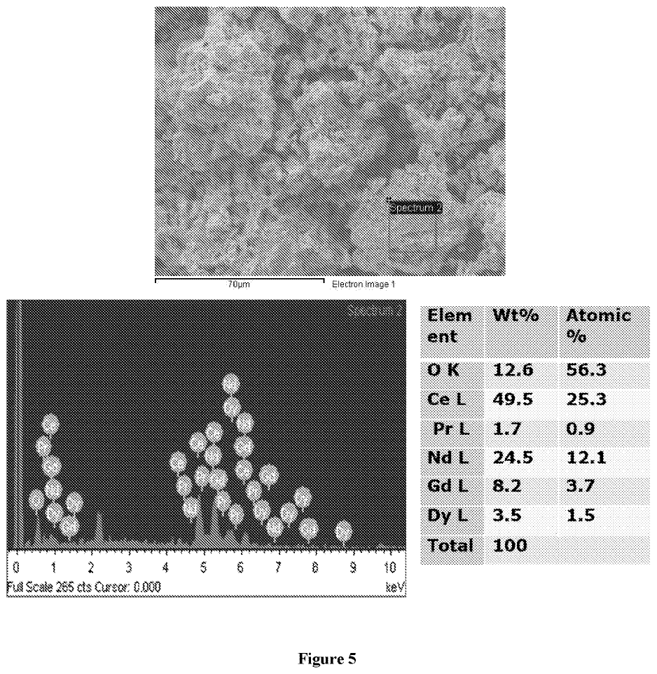

FIG. 6: illustrates X-Ray diffraction pattern of the leaching residue.

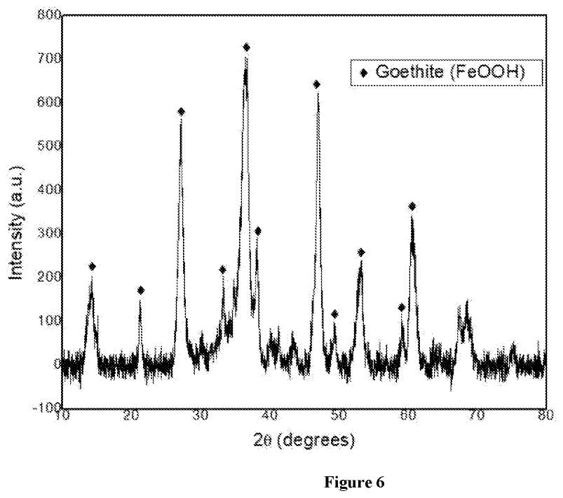

### DETAILED DESCRIPTION OF THE INVENTION

As described hereinbefore, the present invention provides a process for the selective recovery of rare earth elements (REEs) from spent neodymium iron boron (NdFeB) magnets comprising the steps of (a) providing magnet powder post demagnetizing and pulverizing/milling of neodymium iron boron (NdFeB) magnetsfor aeration leaching; (b) performing aeration leaching of said magnetic powder for dissolution of REEs including as rare earth chlorides and completely precipitating iron out as iron oxide and/or hydroxide by-product based on oxidation of Fe²+ to Fe³+ during said aeration leaching and thus generating a mother liquor containing the rare earth chlorides that is followed by (c) reacting the filtered said mother liquor with oxalic acid to precipitate rare earth elements as rare earth oxalate for further calcination and obtaining rare earth oxide for recovery of rare earth elements (REEs) therefrom,

which process is advantageously capable of selective recovery of rare earth elements (REEs) from spent neodymium iron boron (NdFeB) magnets that is advantageously low in acid consumption, involves low capital cost and low reagent consumption and at the same time enables iron oxide and/or hydroxide as by-product.

The present invention thus relates to the selective recovery of rare earth elements (REEs) from spent NdFeB magnets. Magnet powder is leached and oxidizing the Fe²+ to Fe³+ due to the fact that the Fe²+ doesn't precipitate and remains in the solution below pH 7. Further, the process comprises filtering the leached slurry to separate mother liquor and a residue containing rare earth salts and iron oxides and/or hydroxides, respectively.

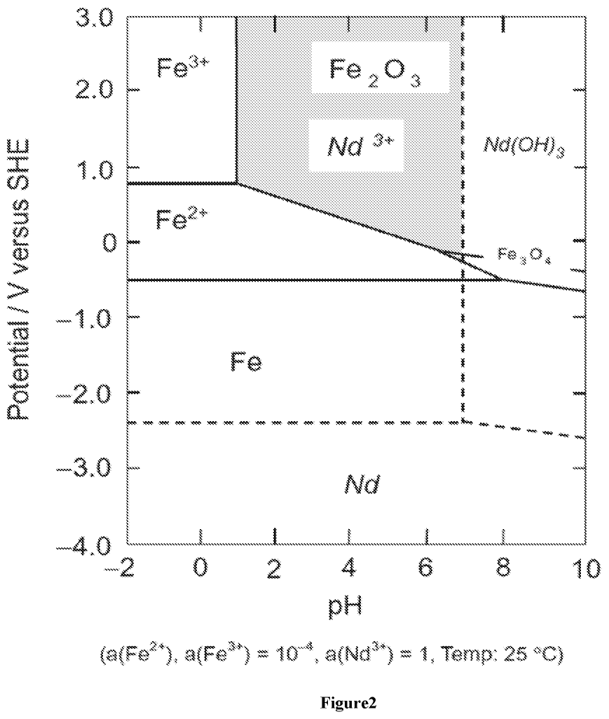

Precipitating the rare earth salts to rare earth oxalates followed by calcination gives rare earth oxide compound. This process decreases the acid consumption during the selective recovery of rare earth elements, besides regenerating acid for leaching. So, the process of the present invention only consumes oxalic acid.
In step (a), rare earth elements containing magnets are demagnetized at a temperature above 300 °C for a duration of 1 hr then the demagnetized material is pulverized to a size of <90 μm.
In step (b), the material obtained from step (a) was added to water and acid/ferrous/ferric salt and leached for a duration of 1-12 hours at a pH in the range of 1 to 7 at a temperature of leaching is in the range of RT to 100 °C. During acid leaching, both rare earths and iron from the magnet dissolve in the form of rare earth salts and ferrous salts. The leaching operation was carried out in the presence of air so that the dissolved oxygen reacts with ferrous salt and converts it to ferric salt. The ferric salt is not stable at the given pH and dissociates into iron oxide and/or hydroxide and releases the acid. The acid further reacts with the undissolved magnet and dissolves rare earths and iron. This process continues until the rare earths are completely dissolved, or the acid is completely consumed. During leaching, the acid concentration must be such that it is high enough to start iron precipitation and low enough to keep rare earths in the solution (pH 2-6), which can be depicted in FIG. 2. The reactions occur during leaching are given below:

$${RE}_{2} {Fe}_{14} B + HCl + {H}_{2} O = {RECl}_{3} + {FeCl}_{2} + {H}_{3} {BO}_{3} + {H}_{2} ↑ \qquad ( 1 )$$

$$\text{?} \qquad ( 2 )$$

$$R 2 Fe 14 B + 6 HCl + 02 = 2 RECb + Fe 2 O 3 \cdot x H 2 OJ + H 3 BQ 3 + 2 H 2 j \qquad ( 3 )$$

$$\text{?} \text{indicates text missing or illegible when filed}$$

As a result, obtaining a pregnant liquor containing rare earth salts and a residue containing iron oxides and/or hydroxides.
The obtained mother liquor from step (b), which has almost negligible Fe²+ is sent for the precipitation step in (c) wherein pregnant liquor containing rare earth salts may be reacted with oxalic acid to precipitate rare earth elements in the form of rare earth oxalate, as shown in the below equation (6).

2RECb+3H2C2O4 - - - *RE2(C2O4)3+6HCl (6)
The rare earth oxalates are calcined in air at 800 °C to obtain rare earth oxide as shown in the below equation (7).

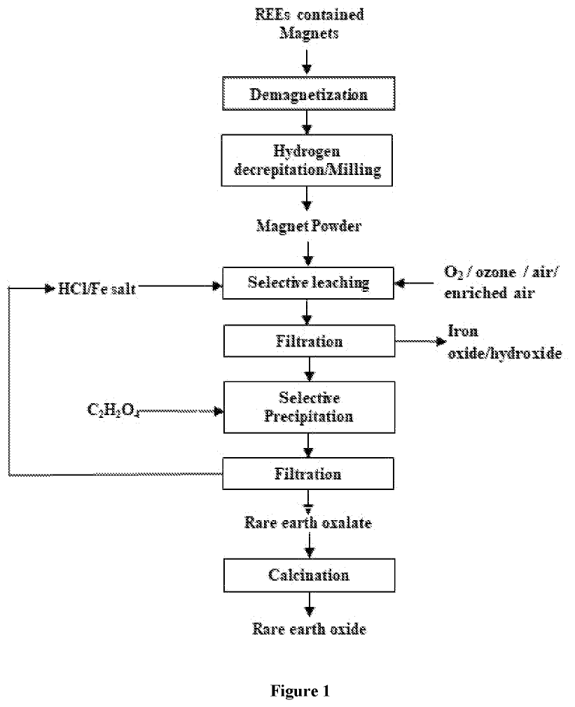

RE2(C2O4)3+02 - - - *2RE2O3+12CO2 (7)
The process of the present invention not only decreases the acid consumption for leaching and decreases the reagent consumption for the precipitation process. This process also avoids the energy-intensive high-temperature oxidation process for selective recovery of rare earths from magnets. Furthermore, about 99% of REEs with 99% purity can be recovered from this process. The process flowchartillustrated in FIG. 1.

The unique process of the present invention enables the following:
Selective dissolution of REEs by aeration leaching.
Closed loop process with only oxalic acid consumption.

The non-obviousness of the process of the present invention relates to completely precipitating out of iron from the solution by oxidizing Fe²+ to Fe³+ using aeration leaching and obtaining iron oxide and/or hydroxideas a by-product.

The selective advantages of the process of the present invention as a betterment of the existing processes are based on the following process features:
Low acid consumption
Low capital cost
Low reagent consumption
Iron oxide by-product

### EXAMPLES

### Example 1

In a preferred process of the present invention 5 g of pulverized magnet powder of composition 64.40% iron, 25.60% neodymium, 0.92% dysprosium, 3.72% praseodymium, 1.66% chromium, 1.03% cobalt, 0.91% nickel, 0.34% aluminum by weight of size <90 μm was added to water and HCl in a 500-mL flask with three necks heated on a hot plate magnetic stirrer to maintain the flask temperature within ±1 °C in a 10:1 ratio, leaching time is in the range of 1-12 hours at a pH in the range of 3 to 7 at a leaching temperature in the range of RT to 90 °C with 600 rpm stirring speed. The solution volume was kept constant throughout the experiment by connecting a condenser to one of the necks to reduce water evaporation. An air pump was connected to another neck to supply oxygen to oxidize the Fe²+ to Fe³+. Magnet powder is leached and oxidizing the Fe²+ to Fe³+ due to the fact that the Fe²+ doesn't precipitate and remains in the solution below pH 7 as depicted in ______. The flask was stirred constantly using a magnetic stir bar to ensure the homogeneity of the slurry. After every hr elapsed, the pH and oxidation-reduction potential ______. of the slurry was measured. The slurry was filtered using a gouch crucible and a vacuum filtration system followed by titrating the filtered solution with a potassium permanganate solution to determine the iron percentage. Images of the residue with and without connecting aim pump is shown in ______ 3. When ORP shows a positive value, it is ensured that the iron starts to get oxidized, and a negligible percentage of iron was observed when it reached +200 mV. The leaching experiment stopped when the percentage of iron reached negligibly and filtered the slurry using filter paper. Next, this leach liquor was mixed with oxalic acid to precipitate REEs in the form of rare earth oxalates. Further, these rare earth oxalates calcined at 850 °C for 1 hr to produce rare earth oxides. REEs recovered in the final product which was about 99% rare earth oxides. The XRD pattern and SEM-EDAX analysis are shown in ______ 4. respectively. The XRD pattern of the leaching residue is shown in ______.

In a three-neck flask, 5 g of magnet powder was combined with 50 mL of a stoichiometric solution of hydrochloric acid (for rare earths and other elements except for iron) at 90 °C with 600 rpm. Keep the flask on a hot plate magnetic stirrer, and was stirred constantly using a magnetic stir bar to ensure the homogeneity of the solution. The solution volume was kept constant throughout the experiment by connecting the condenser to one of the necks of the flask to control water evaporation. An air pump was connected to another neck of the flask to supply oxygen to oxidize the iron in the solution. After every hr elapsed, take out the solution with a micropipette and check its pH and Eh with a combo pH-ORP meter then filter one mL solution using a gouch crucible and combine the leftover solution into the slurry. The obtained residue was washed and dried properly then performed X-Ray Diffraction to know the phases present in the residue. When ORP shows +200 mV, there was no iron present in the slurry then excess acid was added to dissolve other elements present in the magnet powder. The leached liquor was mixed with oxalic acid to get rare oxalate and further calcined at 800 °C in order to get rare earth oxide. REEs recovered in the final product which was about 99% rare earth oxides.

### Example 3

A leaching experiment was performed as described in Example I but with 5 g of pulverized magnet powder of composition 58.67% iron, 11.23% neodymium, 21.84% x′cerium, 2.74% praseodymium, 2.69% gadolinium, 0.69% nickel, 0.60% aluminum by weight. REEs recovered in the final product which was 98% rare earth oxides.

It is thus possible for the present advancement to provide aprocess for the selective recovery of rare earth elements (REEs) from spent neodymium iron boron (NdFeB) magnets that is advantageously low in acid consumption, involves low capital costand low reagent consumption and at the same time enabling iron oxide and/or hydroxide as a by-product.

1. A process for the selective recovery of rare earth elements (REEs) from spent neodymium iron boron (NdFeB) magnets comprising the steps of
(a) providing magnet powder post demagnetizing and pulverizing/milling of neodymium iron boron (NdFeB) magnetsfor aeration leaching;
(b) performing aeration leaching of said magnetic powder for selective dissolution of REEs including as rare earth salts and completely precipitate iron out as iron oxide/hydroxide by-product based on oxidation of Fe2+ to Fe3+ during said aeration leaching and thus generating a mother liquor containing the rare earth chlorides;
(c) reacting the filtered said mother liquor with oxalic acid to precipitate rare earth elements as rare earth oxalate for further calcination and obtaining rare earth oxide and/or hydroxide for recovery of rare earth elements (REEs) therefrom.

2. The process for the selective recovery of rare earth elements (REEs) as claimed in claim 1 wherein said step (a) involves demagnetizationof neodymium iron boron (NdFeB) magnetsat a temperature above curie temperature (400-500 °C), for a duration of 1 hr where magneticproperties disappear including by involving externally applied magnetic field, mechanical shock treatment, that is followed by pulverizing the demagnetized material to a size of <500 μm based on mechanically pulverizing by including hydrogen decrepitation and/or grinding, ball milling to obtain said magnet powder with an enhanced surface area that is sieved to obtain both undersize and oversize powders.

3. The process for the selective recovery of rare earth elements (REEs) as claimed in claim 1 wherein said step (b) of performing aeration leaching by selective dissolution of REEs as rare earth salts involve adding said undersized and oversized magnet powders to water and acid where both REEs and ferrous/ferric salt were leached in the presence of air for a duration of 1-12 hours at a pH in the range of 1 to 7 at a temperature of leaching in the range of room temperature of 20-40 °C to 100 °C and with 5-2000 rpm stirring speed, providing rare earth salts and ferrous salts that reacts with dissolved oxygen of the air or enriched oxygen of the air or oxygen or ozone to be converted to ferric salts that in unstable in the pH range to be dissociated to iron oxide and/or hydroxide for releasing the acid which acid further reacts with the undissolved magnet powder for continuing the process of aeration leaching until the magnet powder is completely consumed to thereby favour mother liquor containing rare earth salts and a residue containing iron oxides and/or hydroxides as by-product obtained in yields of more than 90%.

4. The process for the selective recovery of rare earth elements (REEs) as claimed in claim 1 wherein in said step (b) said magnet powder to acid is provided in the ratio range of 1:2 to 1:100 with said acid including organic, inorganic acids.

5. The process for the selective recovery of rare earth elements (REEs) as claimed in claim 1 wherein said step (c) involves reacting the filtered mother liquor minus the residue including iron oxides and/or hydroxides and having negligible Fe2+, with oxalic acid to precipitate rare earth elements (REEs) in the form of rare earth oxalates that was calcined in air at 800 °C to obtain rare earth oxides.

6. The process for the selective recovery of rare earth elements (REEs) as claimed in claim 1 wherein during leaching in step (b) the acid concentration is such that it is high enough to start iron precipitation and low enough to keep rare earths in the solution in pH range of 1-6.

7. The process for the selective recovery of rare earth elements (REEs) as claimed in claim 1 facilitating decreased acid consumption for selective recovery of rare earths from magnets with attainable REEs yield of 99% with 99% purity vide the process.

8. The process for the selective recovery of rare earth elements (REEs) as claimed in claim 1 wherein spent neodymium iron boron (NdFeB) magnets include pre-consumer scrap and residues, including magnetic swarf, rejected magnets, REEs containing residue during metal production, electric arc furnace residue, and industrial residue, or end-of-life products comprised of compact fluorescentlamps, LEDs, LCD backlights, plasma screens, cathode ray tubes, magnets, automobiles (motor magnets, switches, sensors, actuators), mobile phones (speakers, switches), Hard Disk Drives (HDDs), consumer electric and electronic appliances, electric and hybrid vehicles, windturbine generators, nickel metal halide batteries, and catalysts.
